(19) United States
(12) Patent Application Publication
(10) Pub. No.: US 2007/0071965 A1
(43) Pub. Date: Mar. 29, 2007

(54) Compositions for impregnating paper products and natural fabrics and methods, processes and assemblages therefor

(75) Inventor: Sally Judith Weine Ramsey, Tallmadge, OH (US)

Correspondence Address: WILSON SONSINI GOODRICH & ROSATI, 650 PAGE MILL ROAD, PALO ALTO, CA, 94304-1050, US

(73) Assignee: Ecology Coatings, Inc., Akron, OH (US)

(21) Appl. No.: 11/234,672

(22) Filed: Sep. 23, 2005

(51) Int. Cl. B32B 5/16; B32B 29/00

(52) U.S. Cl. 428/329; 428/331; 428/537.5; 524/493; 524/556

(57) ABSTRACT

Disclosed are compositions which are curable using ultraviolet and visible radiation. In addition, the disclosed compositions are suitable for applying to fiber substrates, such as, but not limited to, paper product and natural fiber fabrics. In addition, methods are disclosed for applying the composition to fiber substrates, or at least a portion of the fiber substrates, and curing of the applied composition to obtain partially or fully cured compositions. Furthermore, articles of manufacture incorporating fully cured compositions are disclosed, including, for example paper; such articles of manufacture are resistant to water, including retention of structural integrity, print and brightness upon prolonged exposure to water. Also disclosed are methods, processes, production lines, assemblages, and factories which incorporate these curable compositions.

### FIELD OF THE INVENTION

Described herein are compositions, methods, processes and assemblages for rendering paper and fiber-based products resistant to water.

### BACKGROUND OF THE INVENTION

A variety of consumer, scientific, and industrial products are composed of natural fibers, such as paper. When exposed to water, these products exhibit reduced structural strength which can lead to tearing or breaks. In addition, ink or pencil writing on these products fades, bleeds, or streaks when exposed to water.

### SUMMARY OF THE INVENTION

Presented herein are porous and/or fiber products that have and retain desirable aesthetic, performance and durability properties when exposed to water, including exposure for prolonged periods of time. The present fiber products exhibit at least one of the following characteristics after exposure to water for at least 1 day: (a) retention of structural integrity; (b) retention of structural strength; (c) retention of ink or pencil writing; (d) retention of print; (e) retention of brightness; and (f) resistance to mold, algae, mildew, bacterial, and/or fungal growth. Also described are fiber products that exhibit at least two of the aforementioned characteristics, at least three of the aforementioned characteristics, at least four of the aforementioned characteristics, at least five of the aforementioned characteristics, or all of the aforementioned characteristics. Also described are fiber products that exhibit or retain at least one of the following characteristics after exposure to water for at least 2 days, at least 3 days, at least 7 days and at least 10 days. Also described are fiber products wherein exposure to water includes soaking, misting, spraying, seeping, or combinations thereof. Also described herein are compositions, methods, strategies, techniques, assemblages and factories for waterproofing porous and/or fiber products. In further embodiments, the waterproofed porous and/or fiber products retain desirable aesthetic, performance and durability properties when exposed to water, including exposure for prolonged periods of time.

The present fiber products comprise compositions, partially cured compositions, and fully cured compositions provided herein. Also presented herein are compositions that can be applied to a fiber substrate, optionally followed by a curing process, to produce a fiber product having at least one of the aforementioned characteristics.

Also described are methods for applying and/or impregnating a fiber product with compositions to produce, upon curing, a fiber product having at least one of the aforementioned characteristics. Also described are methods for centrifugally applying a composition to a porous and/or fiber product wherein the composition impregnates, at least in part, the porous and/or fiber product. Also described are methods for applying a composition described herein on and into a porous and/or fiber product by means of a high pressure sprayer; in further embodiments, a roller is applied to the sprayed surface. Following application of the compositions described herein onto or into a porous and/or fiber product, the composition is cured by means of exposure to actinic radiation. Methods for manufacturing and assemblages for producing the present fiber products are also provided.

One aspect described herein are compositions comprising:
(a) nano-fillers;
(b) at least one photo-initiator;
(c) at least one monofunctional monomer;
(d) a surfactant;
(e) a diluent; and
(f) optionally, a pigment dispersion and a second photoinitiator.
   In an embodiment, the present composition is applied to a fiber substrate, optionally followed by a curing process, to manufacture fiber products having at least one of the aforementioned characteristics.

Another aspect described herein are porous and/or fiber products comprising (a) a porous and/or fiber substrate; and (b) a composition comprising:
(i) nano-fillers;
(ii) at least one photo-initiator;
(iii) at least one monofunctional monomer;
(iv) a surfactant;
(v) a diluent; and
(vi) optionally, a pigment dispersion and a second photoinitiator.

Another aspect described herein are porous and/or fiber products that that exhibit at least one characteristic: (a) retention of writability of pen and/or ink; (b) retention of print; (c) retention of brightness; and/or (d) ability to block absorption of organic solvents (e.g., alcohol, methyl ethyl ketone, etc.). In certain aspects such fiber and/or porous products comprise a cured composition that has been impregnated, at least in part, into the porous and/or fiber product.

Another aspect described herein are porous and/or fiber products that resist the growth of mold, mildew, algae, bacteria and/or fungus. In certain aspects such fiber and/or porous products comprise a cured composition that has been impregnated, at least in part, into the porous and/or fiber product.

Another aspect described herein are porous and/or fiber products that exhibit at least one characteristic after exposure to water for at least 1 day: (a) retention of structural strength; (b) retention of ink or pencil writing; (c) retention of print; and/or (d) retention of brightness.

Yet another aspect described herein are methods of manufacturing the present porous and/or fiber products, said method comprising (a) providing a fiber and/or porous substrate; (b) applying a composition to said fiber and/or porouse substrate to produce a fiber and/or porous product; and (c) curing said fiber and/or porous product, wherein said composition comprises:
(i) nano-fillers;
(ii) at least one photo-initiator;
(iii) at least one monofunctional monomer;
(iv) a surfactant;
(v) a diluent; and
(vi) optionally, a pigment dispersion and a second photoinitiator.
   Fiber products produced by the above method of manufacturing are also presented.

Yet another aspect described herein are assemblages for manufacturing the present porous and/or fiber products, said assemblages comprising (a) means for providing a porous and/or fiber substrate; (b) means for applying a composition to said porous and/or fiber substrate to produce a porous and/or fiber product; and (c) means for curing said porous and/or fiber product, wherein said composition comprises:
(i) nano-fillers;
(ii) at least one photo-initiator;
(iii) at least one monofunctional monomer;
(iv) a surfactant;
(v) a diluent; and
(vi) optionally, a pigment dispersion and a second photoinitiator.
   Porous and/or fiber products produced by the above assemblages for manufacturing are also presented.

Yet another aspect described herein are various methods of using the present porous and/or fiber products. Exemplary applications for the present porous and/or fiber products include labels, books, newspaper, magazines, maps, field manuals, envelopes, paper plates, clothes, shipping materials, vapor barriers, garden markers, underwater markings, sports equipment, gym bags, business cards, cardboard, shower curtains and the like. Additional applications include use of the present porous and/or fiber products to block absorption of aqueous-based solutions, including water from any source, including mudwater, lake water, stream water, tap water, ocean water, sewage water and purified water. Additional applications include use of the present porous and/or fiber products to block absorption of organic solvents, such as alcohol, methyl ethyl-ketone, and the like.

### INCORPORATION BY REFERENCE

All publications, patents and patent applications mentioned in this specification are herein incorporated by reference in their entirety to the same extent as if each individual publication, patent or patent application was specifically and individually indicated to be incorporated by reference.

### BRIEF DESCRIPTION OF THE FIGURES

A better understanding of the features and advantages of the present methods, processes, assemblages, devices and compositions may be obtained by reference to the following detailed description that sets forth illustrative embodiments, in which the principles of our methods, processes, compositions, devices and assemblages are utilized, and the accompanying drawings of which:

FIG. 1 is a flowchart of one possible process for applying the compositions described herein to a fiber substrate.

FIG. 2 is an illustration of one representative method and assemblage for applying the compositions described herein to a fiber substrate, and curing the composition.

FIG. 3 is an illustration of another representative method and assemblage for applying the compositions described herein to a fiber substrate, and curing the composition.

### DETAILED DESCRIPTION OF THE INVENTION

I. Certain Terms

The term “actinic radiation” as used herein, refers to any radiation source which can produce polymerization reactions, such as, by way of example only, ultraviolet radiation, near ultraviolet radiation, and visible light.

The term “co-photoinitiator,” as used herein, refers to a photoinitiator which may be combined with another photoinitiator or photoinitiators.

The term “cure,” as used herein, refers to polymerization, at least in part, of a coating composition.

The term “curable,” as used herein, refers to a coating composition which is able to polymerize at least in part.

The term “curing booster”, as used herein, refers to an agent or agents which boost or otherwise enhance, or partially enhance, the curing process.

The term “fiber substrates” as used herein, refers to any object which is, contains, or is derived from a natural fiber; such objects encompass:
(a) various types of paper products of any basis weight or grammage, bulk, caliper or thickness, machine and cross direction, smoothness, such as, but not limited to, abrasive paper, absorbent paper, acid free paper, acid proof paper, adhesive paper, air filter paper, air mail paper, album paper, albumin paper, alkaline paper, aluminum foil lamination paper, ammunition paper, anti rust paper, antique paper, archival paper, art paper, asphalt laminated paper, azurelaid paper, bag paper, banknote or currency paper, barograph paper, base paper, bible paper, blade wrapping paper, butcher paper, blotting paper, blueprint paper, board, bond paper, book paper; boxboard, bristol board, business form paper, carbon paper, cardboard, cartridge paper, catalog paper, check or cheque paper, chipboard, cigarette paper, coarse paper (also industrial paper), coffee filter paper, color-fast papers, construction paper, containerboard, copier paper or laser paper, corrugated board, cotton paper or rag paper, cover paper, crepe paper, cut sheet, directory paper, document paper, drawing paper, duplex board, duplex paper, electrical grade paper, envelop paper, fiberboard, filter paper, Fine Papers, Fluorescent Paper, Folding Boxboard, Freesheet, Gasket Board, Glassine Paper, Glazed Paper, Gray Board, Green Paper, Groundwood Papers, Handmade Paper, Index Paper, Industrial Papers, Insulating Board, Ivory Board, Kraft Bag Paper, Kraft Paper, Kraftliner, Label Paper, Laid Paper, Laminated Linerboard, Ledger Paper, Light Weight Paper, Linen Paper, Liner, Linerboard, Manifold Paper, Manila, Mechanical Paper, Millboard, Newsprint, Offset Paper, Packaging Paper, Paperboard, Permanent Paper, Photographic Paper, Poster Paper, Pulp Board, Rag Paper, Rice Paper, Safety Paper, Sanitary Papers, Sanitary Tissue Paper, Security paper, Sized Paper, Solid Fiberboard, Stamp Paper, Strawboard, Tag Paper, Tea Bag Paper, Text Paper, Thin Paper, Tissue, Transparent Paper, Union Kraft, Vegetable Parchment, Vellum Paper, Wall Paper, Water-Color Paper, Waxed Paper, Wrapper, Writing Paper, Yellow Pages, and the like;
(b) various types of pulp containing products;
(c) various type of shipping materials, such as, but not limited to, envelopes, bags, boxes, packages, labels, and the like;
(d) various types of marker, such as, but not limited to, garden markers, underwater markers, soil markers, and the like;
(e) various types of natural fiber fabrics, such as, but not limited to, cotton, wool, linen, cashmere, hemp, rampie, silk, and the like;
(f) various types of natural fiber knits, such as, but not limited to, cotton, wool, linen, hemp, rampie, silk, and the like; and
(g) fiber substrates which have non-fiber components, such as, but not limited to, buttons, zippers, pins, staples, clips, rods, and the like.

The term “filler” refers to a relatively inert substance, added to modify the physical, mechanical, thermal, or electrical properties of a coating.

The term “inorganic pigment’, as used herein, refers to ingredients which are particulate and substantially nonvolatile in use, and includes those ingredients typically labeled as inerts, extenders, fillers or the like in the paint and plastic trade.

The term “irradiating,” as used herein, refers to exposing a surface to actinic radiation.

The term “milling” as used herein, refers to the processes of premixing, melting and grinding a powder coating formulation to obtain a powder suitable for spraying.

The term “monomers,” as used herein, refers to substances containing single molecules that can link to oligomers and to each other.

The term “photoinitiators,” as used herein, refers to compounds that absorb ultra-violet light and use the energy of that light to promote the formation of a dry layer of coating.

The term “polymerizable pigment dispersions,” as used herein, refers to pigments attached to polymerizable resins which are dispersed in a coating composition.

The term “polymerizable resin” or “activated resin,” as used herein, refers to resins which possess reactive functional groups.

The term “pigment,” as used herein, refers to compounds which are insoluble or partially soluble, and are used to impart color.

The term “retention of brightness” as used herein, refers to the ability of a material to retain at least about 90% of its brightness. Retention of brightness prevents discoloration, such as darkening or yellowing, of a material. Representative tests for determining retention of brightness include spectrophotometric tests, such as optical absorption test for brightness (wavelength=457 nm) and/or luminance (wavelength=555 nm), for example.

The term “retention of ink or pencil writing” as used herein, refers to the ability of ink or pencil writing to be at least about 90% retained on a material. Retention of ink or pencil writing prevents bleeding, fading, and/or streaking on a material. Representative tests for determining retention of ink or pencil writing include spectrophotometric tests, such as the Ink Elimination (IE) test and the Effective Residual Ink Concentration (ERIC) test, for example

The term “retention of print” as used herein, refers to the ability of print to be at least about 90% retained on a material. Representative prints include various ink prints, such as labels, logos, and the like. Retention of print prevents bleeding, fading, and/or streaking on a material. Representative tests for determining retention of print include various spectral photometric tests.

The term “retention of structural strength” as used herein, refers to the ability of a material to retain at least about 90% of its physical and structural integrity, strength, or durability. Retention of structural strength prevents tearing, ripping, or breaks. Representative mechanical tests for determining retention of structural strength include manual inspection, folding endurance, and tensile strength, for example. Spectral photometric tests may also be employed to determine retention of structural strength.

The term “retention of writability of pencil and/or ink” as used herein, refers to the ability of a material to retain at least about 90% of its ability to be written upon by any type of pencil or any source of ink, such as a pen or printer. Writability depends on the absorbency of a material.

The term “vehicle” as used herein, refers to the liquid portion of solvent based formulations, and can incorporate both the solvent and the resin.

II. Compositions

An aspect described herein are compositions comprising:
(a) nano-fillers;
(b) at least one photo-initiator;
(c) at least one monofunctional monomer;
(d) a surfactant;
(e) a diluent; and
(f) optionally, a pigment dispersion and a second photoinitiator.
   In an embodiment, compositions provided herein are applied to fiber substrates to produce fiber products having desirable properties.

The present composition comprises nano-fillers in an amount of 20-60% by weight of the total weight of the composition (wt/wt). In a further or alternative embodiment, the present composition comprises at least one photo-initiator in an amount of 0.5-10% wt/wt. In a further or alternative embodiment, the present composition comprises at least one mono-functional monomer in an amount of 2-80% wt/wt. In a further or alternative embodiment, the present composition comprises a diluent in an amount of 2-22% wt/wt. In a further or alternative embodiment, the present composition comprises a surfactant in an amount of 0.01-2.0% wt/wt. In a further or alternative embodiment, the present composition comprises a pigment dispersion in an amount of 1-12% wt/wt and a second photoinitiator in an amount of 0.5-5% wt/wt.

Compositions described herein can be applied to various fiber substrates to produce fiber products. Compositions described herein are curable by various sources of visible radiation, near visible radiation, ultra-violet (UV) radiation, and combinations thereof. UV radiation can be selected from the group consisting of UV-A radiation, UV-B radiation, UV-B radiation, UV-C radiation, UV-D radiation, or combinations thereof.

Coating flexibility may be an important characteristic for compositions herein when applied to objects which flex, distort, or otherwise change shape, such as, but not limited to, fabrics and cloths. Coating flexibility allows the composition to flex or distort without cracking when the object flexes, distorts or changes shape; whereas coating adhesion properties allows the coating to remain attached to the object when the object flexes, distorts or changes shape. Certain embodiments of the compositions described herein may be used to obtain and optimize desirable properties.

A. Nano-Fillers

The present composition comprises nano-fillers. Nano-fillers can be either insoluble inorganic particles, or insoluble organic particles. The inorganic nano-fillers are generally metal oxides, although other inorganic compounds can be used. Examples of inorganic nano-fillers include aluminum nitrides, aluminum oxides, antimony oxides, barium sulfates, bismuth oxides, cadmium selenides, cadmium sulfides, calcium sulfates, cerium oxides, chromium oxides, copper oxides, indium tin oxides, iron oxides, lead chromates, nickel titanates, niobium oxides, rare earth oxides, silicas, silicon dioxides, silver oxides, tin oxides, titanium dioxides, zinc chromates, zinc oxides, zinc sulfides, zirconium dioxides, and zirconium oxides. Alternatively, organic nano-fillers are generally polymeric materials ground into appropriate sized particulates. Examples of nanometer sized organic nano-fillers include, but are not limited to, nano-polytetrafluoroethylene, acrylate nanosphere colloids, methacrylate nanosphere colloids, and combinations thereof, although micron sized fillers of the polytetrafluoroethylene, acrylate, methacrylate, and combinations thereof may be used.

In one embodiment, the present compositions comprise nano-alumina. Nano-alumina is composed of high purity aluminum oxide that is of nanometer size, including by way of example less than 200 nm, and within the range of approximately 5-40 nanometer discrete spherical particles. Nano-alumina imparts excellent optical clarity, gloss and physical properties. Nano-alumina-based compositions find use in abrasion resistant coating applications requiring superior optical transparency such as eye glasses; fine polishing applications, including semiconductors; and nanocomposite applications, including improved thermal management. In addition, incorporation of nano-alumina can give rise to compositions with improved impact resistance, abrasion resistance and scratch resistance.

In another embodiment, the present compositions comprise nano-silicon dioxide. Nano-silicon dioxides having a nanometer size, including by way of example less than about 200 nm, and by way of further example, with an average particle size 5 to 40 nm, can be incorporated into compositions. Addition of nano-silicon dioxides may impart improved toughness, hardness and abrasion and scratch resistance. Other properties and features obtained when incorporating nano-silicon into compositions can include: it acts as a barrier effect against gases, water vapor and solvents, it has increased weathering resistance and inhibited thermal aging, it exhibits reduced cure shrinkage and heat of reaction, reduced thermal expansion and internal stresses, increased tear resistance, fracture toughness and modulus, has improved adhesion to a large number of inorganic substrates (e.g., glass, aluminum), has improved dirt resistance against inorganic impurities (e.g., soot) by a more hydrophilic surface, and has improvements to other desired properties such as: thermal stability, stain-resistance, heat conductivity, dielectric properties.

Representative nano-silicon dioxides include those sold under the name Nanocryl® C by Hanse Chemie (Geesthacht, Germany), such as Nanocryl® C 350, Nanocryl® C 130, Nanocryl® C 140, Nanocryl® C 145, Nanocryl® C 146, Nanocryl® C 150, Nanocryl® C 153, Nanocryl® C 155, Nanocryl® C 165. In an embodiment, Nanocryl® C 155 is included in the present compositions.

Other materials that may be used as nano-fillers include: oxides, carbides, nitrides, borides, silicates, ferrites and titanates. For instance, examples of such nano-fillers are, but not limited to, nano-zirconium oxide, nano-zirconium dioxides, nano-silicon carbide, nano-silicon nitride, nano-sialon (silicon aluminum oxynitride), nano-aluminum nitrides, nano-bismuth oxides, nano-cerium oxides, nano-copper oxides, nano-iron oxides, nano-nickel titanates, nano-niobium oxides, nano-rare earth oxides, nano-silver oxides, nano-tin oxides, and nano-titanium oxides. These materials have relatively high mechanical strength at high temperatures.

Alternatively, nano-fillers used in the composition described herein include amorphous silicon dioxide prepared with polyethylene wax, synthetic amorphous silica with organic surface treatment, untreated amorphous silicon dioxide, alkyl quaternary bentonite, colloidal silica, acrylated colloidal silica, alumina, zirconia, zinc oxide, niobia, titania aluminum nitride, silver oxide, cerium oxides, and combinations thereof. The silicon dioxides are chosen from a group consisting of both synthetic and natural silicon dioxides with surface treatments including polyethylene wax or waxes and IRGANOX® from Ciba Specialty Chemicals 540 White Plains Road, Tarrytown, N.Y., U.S.A.

The average particle size of nano-fillers in the compositions described herein includes by way of example less than about 20 μm, and by way of further example, with an average particle size 1 to 10 μm discrete particles; whereas, the average particle size of nano-filler particles includes by way of example less than about 200 nm, and by way of further example, with an average particle size 5 to 50 nm discrete particles. In an embodiment, nano-filler particles have an average diameter of 10, 20, 30, or 40 nm. Furthermore, in another embodiment, the particle size distribution of nano-filler particles ranges from 1 nm to 60 nm, such as from 5 nm to 30 nm.

Nano-fillers are present in the compositions in an amount ranging from 20 to 60% wt/wt, such as from 25 to 55% wt/wt, 30 to 50% wt/wt, or 30 to 40% wt/wt. In an embodiment, the present compositions comprise from 33-36% wt/wt.

The addition of fillers imparts certain rheological properties to the composition, such as viscosity; however, the addition of nanoscale fillers imparts dramatically different effects on the coating mechanical properties in comparison to micron scale fillers. Thus, the mechanical properties of the composition can be manipulated by varying the amount of micron sized fillers and nano-fillers.

Improved properties attributable to nano-fillers include improved tensile strength, modulus, heat distortion temperature, barrier properties, UV resistance, abrasion and scratch resistance, and conductivity. The incorporation of certain nano-fillers, such as nano-alumina and nano-silicon, can provide favorable long-term coating without significantly effecting optical clarity, gloss, color or physical properties. These improved properties may be in large part due to the small size and large surface area of the nanoscale fillers.

B. Photo-Initiators

In a further or alternative embodiment, the present composition comprises at least one photo-initiator. In a further or alternative embodiment, the present composition comprises at least two photo-initiators. In a further or alternative embodiment, the present composition comprises at least three photo-initiators.

Generally, photo-initiators are added to initiate rapid polymerization of monomers in the composition upon exposure to a source of actinic radiation, such as ultraviolet light. The photo-initiator can be matched to the spectral properties of the UV source, such as medium pressure mercury arc lights which produce intense TV-C (200-280 nm) radiation, doped mercury discharge lamps which produce UV-A (315-400 nm) radiation, or UV-B (280-315 nm) radiation depending on the dopant, or combination of lamp types. Depending on the photo-initiator or combination of photo-initiators in the composition, varying UV source(s) may be employed.

Any suitable type of photo-initiator may be used in the composition, including those categorized as free radicals. The photo-initiator may be in liquid or solid form. Furthermore, combinations of photo-initiators may be used which encompass different spectral properties of the UV sources used to initiate polymerization.

The photo-initiator may be selected from a group consisting of diphenyl (2,4,6-trimethylbenzoyl)phosphine oxide, benzophenone, ESACURE® KTO, IRGACURE® 184, IRGACURE® 500, DARACUR® 1173, Lucirin® TPO, 1-hydroxycyclohexyl phenyl ketone, 2-hydroxy-2-methyl-1-phenyl-propan-1-one, 2,4,6,-trimethylbenzophenone, 4-methylbenzophenone, oligo (2-hydroxy-2-methyl -1-(4-(1-methylvinyl)phenyl)propanone), and combinations thereof. In addition, the photo-initiators may be selected from a group consisting of phosphine oxide type photoinitiators, diphenyl (2,4,6-trimethylbenzoyl) phosphine oxide, benzophenone, 1-hydroxycyclohexyl phenyl ketone, 2-hydroxy-2-methyl-1-phenyl-propan-1-one (DAROCUR® 1173 from Ciba Specialty Chemicals 540 White Plains Road, Tarrytown, N.Y., U.S.A.)), 2,4,6-trimethylbenzophenone and 4-methylbenzophenone, ESACURE® KTO 46 (Lamberti S.p.A., Gallarate (VA), Italy), oligo(2-hydroxy-2-methyl-1-(4-(1-methylvinyl)phenyl)propanone), amine acrylates, thioxanthones, benzyl methyl ketal, and mixtures thereof. Furthermore, the photo-initiators may be selected from 2-hydroxy-2-methyl-1-phenyl-propan-1-one (DAROCUR® 1173 from Ciba Specialty Chemicals 540 White Plains Road, Tarrytown, N.Y., U.S.A.), phosphine oxide type photoinitiators, IRGACURE® 500, 819, or 1700 (Ciba Specialty Chemicals 540 White Plains Road, Tarrytown, N.Y., U.S.A.), amine acrylates, thioxanthones, benzyl methyl ketal, and mixtures thereof.

Other photo-initiators which are suitable for use in the practice of the present invention include, but are not limited to, 1-phenyl-2-hydroxy-2-methyl-1-propanone, oligo {2-hydroxy-2 methyl-1-4-(methylvinyl)phenylpropanone)}, 2-hydroxy 2-methyl-1-phenyl propan-1 one, bis (2,6-dimethoxybenzoyl)-2,4,4-trimethylpentyl phosphine oxide, 1-hydroxycyclohexyl phenyl ketone and benzophenone as well as mixtures thereof. Still other useful photoinitiators include, for example, bis(n,5,2,4-cyclopentadien-1-yl)-bis 2,6-difluoro-3-(1H-pyrol-1-yl) phenyl titanium and 2-benzyl-2-N,N-dimethyl amino-1-(4-morpholinophenyl)-1-butanone. These compounds are IRGACURE® 784 and IRGACURE® 369, respectively (both from Ciba Specialty Chemicals 540 White Plains Road, Tarrytown, N.Y., U.S.A.) While, still other useful photoiniators include, for example, 2-methyl-1-4(methylthio)-2-morpholinopropan-1-one, 4-(2-hydroxy)phenyl-2-hydroxy-2-(methylpropyl)ketone, 1-hydroxy cyclohexyl phenyl ketone benzophenone, (cyclopentadienyl)(1-methylethyl)benzene-iron hexafluorophosphate, 2,2-dimethoxy-2-phenyl-1-acetophen-one 2,4,6-trimethyl benzoyl-diphenyl phosphine oxide, benzoic acid, 4-(dimethyl amino)-ethyl ether, as well as mixtures thereof.

In a further or alternative embodiment, the present composition comprises at least one photo-initiator comprising α-hydroxyketone, such as 1-hydroxy-cyclohexyl-phenyl-ketone. In another or alternative embodiment, the present composition comprises at least one photo-initiator comprising benzophenone. In another or alternative embodiment, the present composition comprises at least one photo-initiator comprising a benzoyl diaryl phosphine, such as 2,4,6-trimethylbenzoyl)diphenylphosphine oxide.

In an embodiment, the present composition comprises a combination of photo-initiators. In an embodiment, the present composition comprises IRGACURE® 184 and IRGACURE® 500. In another embodiment, the present composition comprises IRGACURE® 184, IRGACURE® 500, and Lucirin® TPO.

The photo-initiator(s) are present in the compositions in an amount ranging from 0.5-10% wt/wt, such as from 1 to 9% wt/wt, 3 to 8% wt/wt, or 4 to 6% wt/wt.

In another embodiment, the present composition comprises a combination of photo-initiators, wherein each photo-initiator is present in an amount ranging from 0.5-5% wt/wt, such as from 1 to 4% wt/wt or 2 to 3% wt/wt. In yet another embodiment, the present composition comprises IRGACURE® 184 in an amount ranging from 2 to 6% wt/wt, such as about 2, 3, 4, 5, or 6% wt/wt and IRGACURE® 500 in an amount ranging from 0.5 to 4% wt/wt, such as about 0.5, 1, 2, 3, or 4% wt/wt.

In an embodiment, the present compositions comprise a pigment dispersion and a second photo-initiator comprising benzoyl diaryl phosphine oxide. Although the presence of pigments can absorb radiation both in the UV and visible light regions and reduce the effectiveness of some types of photo-initiators, phosphine oxide type photo-initiators are effective in pigmented composition, including, by way of example only, black and WV-curable coating materials. Phosphine oxides also find use as photo-initiators for white coatings. In an embodiment, compositions comprise a pigment dispersion and a photoinitiator comprising 2,4,6-trimethylbenzoyl)diphenylphosphine oxide, such as Lucirin® TPO.

In an embodiment, the present composition comprises a photo-initiator comprising benzoyl diaryl phosphine oxide that is present in an amount ranging from 0.5-5% wt/wt, such as from 1 to 4% wt/wt or 2 to 3% wt/wt. In an embodiment, the photo-initiator comprising benzoyl diaryl phosphine oxide may be present in the composition in an amount of about 0.5, 1, 2, 3, or 4% wt/wt.

C. Monomers

The present composition comprises at least one mono-functional monomer. In an embodiment, the present composition comprises a combination of monomers. Upon exposure to a source of actinic radiation, such as ultraviolet light, and in the presence of a photo-initiator, monomers in the composition are rapidly polymerized to form oligomers. Thus, depending on the extent of polymerization, compositions herein may comprise monomers, oligomers, or monomers and oligomers.

The mechanical properties of the present compositions, such as hardness, low shrinkage, high glass transition temperatures (T_{g}), desirable elasticity, and flexibility depend upon the type of monomers and oligomers provided. By way of example only, polyester acrylates combine good abrasion resistance with toughness, whereas urethane acrylates and polyether acrylates can provide flexibility, elasticity and hardness. Thus, the composition described herein combine oligomers and monomers which impart various properties to obtain compositions that are hard, abrasion resistant, scratch resistant, and impact resistant.

The monomers are chosen from a group consisting of 2-phenoxyethyl acrylate, isobornyl acrylate, acrylate ester derivatives, methacrylate ester derivatives, tetrahydrofurfuryl acrylate, trimethylolpropane triacrylate, 2-phenoxyethyl acrylate esters, and cross-linking agents, such as, but not limited to, propoxylated glyceryl triacrylate, tripropylene glycol diacrylate, and mixtures thereof.

The monomer(s) are present in the compositions in an amount ranging from 2-80% wt/wt, such as from 5 to 75% wt/wt, 10 to 60% wt/wt, or 20 to 50% wt/wt. Monomer(s) can be present in an amount of about 5, 10, 20, 30, 40, 50, 60, 70, or 80% wt/wt.

In an embodiment, the present composition comprises 2-phenoxyethyl acrylate in an amount ranging from 4-40% wt/wt, such as from 10 to 30% wt/wt, 10 to 25% wt/wt, or 10 to 15% wt/wt. In an embodiment, the present composition comprises 1,4-butanediol dimethacrylate in an amount ranging from 4-40% wt/wt, such as from 10 to 30% wt/wt, 10 to 25% wt/wt, or 10 to 15% wt/wt. In an embodiment, the present composition comprises tetrahydrofurfuryl acrylate in an amount ranging from 10-40% wt/wt, such as from 15 to 30% wt/wt or 20 to 25% wt/wt.

In another embodiment, the present composition comprises a combination of mono-functional monomers. In yet another embodiment, the present composition comprises at least one mono-functional monomer selected from the group consisting of 2-phenoxyethyl acrylate, 1,4-butanediol dimethacrylate, tetrahydrofurfuryl acrylate, and mixtures thereof. In a further or alternative embodiment, the present composition comprises 2-phenoxyethyl acrylate, 1,4-butanediol dimethacrylate, and tetrahydrofurfuryl acrylate.

In an embodiment, the present composition comprises a combination of monomers, each present in an amount ranging from 4-40% wt/wt, such as from 10 to 30% wt/wt, 10 to 25% wt/wt, or 10 to 15% wt/wt. In an embodiment, the present composition comprises 2-phenoxyethyl acrylate, 1,4-butanediol dimethacrylate, and tetrahydrofurfuryl acrylate, each present in an amount ranging from 4-40% wt/wt.

D. Surfactants

The present compositions comprise at least one surfactant. Surfactants are employed to impart desirable properties to compositions, such as improved slip, scratch resistance, flow, levelling, release, and defoaming.

Examples of surfactants include, but are not limited to, polymers such as polystyrene, polypropylene, polyesters, styrene-methacrylic acid type copolymers, styrene-acrylic acid type copolymers, polytetrafluoroethylene, polychlorotrifluoroethylene, polyethylenetetrafluoroethylene type copolymers, polyaspartic acid, polyglutamic acid, and polyglutamic acid-γ-methyl esters, and modifiers such as silane coupling agents and alcohols. Additional surfactants include olefins, such as polyethylene, polypropylene, polybutadiene, and the like; vinyls, such as polyvinylchloride, polyvinylesters, polystyrene; acrylic homopolymers and copolymers; phenolics; amino resins; alkyds, epoxys, siloxanes, nylons, polyurethanes, phenoxys, polycarbonates, polysulfones, polyesters (optionally chlorinated), polyethers, acetals, polyimides, and polyoxyethylenes. Further exemplary surfactants include cross-linked as well as non-crosslinked acrylates that are compatible with UV curing compositions, such as crosslinkable silicone acrylate.

Exemplary surfactants include those manufactured under the name TEGO® Rad by Degussa AG (Essen, Germany) and include TEGO® Rad 2100, 2200, 2250, 2300, 2500, 2600, 2650, and 2700.

The surfactant(s) are present in the compositions in an amount ranging from 0.01-2.0% wt/wt, such as about 0.01, 0.02, 0.03, 0.04, 0.05, 0.06, 0.07, 0.08, 0.09, 1.0, 1.2, 1.4, 1.6, 1.8, or 2.0 % wt/wt.

E. Diluent

The present composition comprises at least one diluent. In an embodiment, the diluent is appropriate for diluting oligomers. In another embodiment, the present composition comprises a reactive diluent that produces polymers through the formation of free radicals when exposed to a source of actinic radiation, such as ultraviolet light.

Reactive diluents suitable for addition to the present composition exhibit at least one of the following properties: (a) high UV reactivity; (b) low shrinkage; (c) good balance of hardness and flexibility; (d) high UV stability after polymerization; (e) good viscosity reduction; and/or (f) low toxicity and irritancy.

Representative diluents include, but are not limited to, isobornyl acrylate, isodecyl acrylate, trimethylolpropane triacrylate (TMPTA), di-trimethylolpropane triacrylate (Di-TMPTA), propoxylated TMPTA (PO6-TMPTA), and combinations thereof. In certain embodiments, diluents that may be employed in the present composition are also categorized as mono-functional or multi-functional monomers, described and listed herein.

The present composition comprises at least one diluent in an amount ranging from 2-20% wt/wt, such as from 5 to 18% wt/wt, 7 to 15% wt/wt, or 10 to 12% wt/wt. In an embodiment, the present composition comprises isobornyl acrylate in an amount ranging from 2-20% wt/wt, such as from 5 to 18% wt/wt, 7 to 15% wt/wt, or 10 to 12% wt/wt.

F. Pigments and Pigment Dispersions

The present compositions may optionally comprise at least one pigment or pigment dispersion. Pigments, are insoluble white, black, or colored material, typically suspended in a vehicle for use in a paint or ink, and may also include effect pigments such as micas, metallic pigments such as aluminum, and opalescent pigments. Pigments are used in coatings to provide decorative and/or protective functions however, due to their insolubility, pigments may be a possible contributing factor to a variety of problems in liquid coatings and/or dry paint films. Examples of some film defects thought to be attributable to pigments include: undesirable gloss due to aggregates, blooming, pigment fading, pigment flocculation and/or settlement, separation of pigment mixtures, brittleness, moisture susceptibility, fungal growth susceptibility, and/or thermal instability.

Various organic pigments can be used in the compositions described herein, including, but not limited to, carbon black, azo-pigment, phthalocyanine pigment, thioindigo pigment, anthraquinone pigment, flavanthrone pigment, indanthrene pigment, anthrapyridine pigment, pyranthrone pigment, perylene pigment, perynone pigment and quinacridone pigment.

Various inorganic pigments can be used in the compositions described herein, for example, but not limited to, titanium dioxide, aluminum oxide, zinc oxide, zirconium oxide, iron oxides: red oxide, yellow oxide and black oxide, Ultramarine blue, Prussian blue, chromium oxide and chromium hydroxide, barium sulfate, tin oxide, calcium, titanium dioxide (rutile and anatase titanium), sulfate, talc, mica, silicas, dolomite, zinc sulfide, antimony oxide, zirconium dioxide, silicon dioxide, cadmium sulfide, cadmium selenide, lead chromate, zinc chromate, nickel titanate, clays such as kaolin clay, muscovite and sericite.

In further or alternative embodiments, the present composition comprises polymerizable pigment dispersions that comprise of at least one pigment attached to an activated resin; wherein the activated resin is selected from a group consisting of acrylate resins, methacrylate resins, and vinyl resins, and the pigment is selected from a group consisting of carbon black, rutile titanium dioxide, organic red pigment, phthalo blue pigment, red oxide pigment, isoindoline yellow pigment, phthalo green pigment, quinacridone violet, carbazole violet, masstone black, light lemon yellow oxide, light organic yellow, transparent yellow oxide, diarylide orange, quinacridone red, organic scarlet, light organic red, and deep organic red. These polymerizable pigment dispersions are distinguishable from other pigment dispersions which disperse insoluble pigment particles in some type of resin and entrap the pigment particles within a polymerized matrix. The pigment dispersions used in the compositions and methods described herein have pigments treated such that they are attached to acrylic resins; consequently the pigment dispersion is polymerizable upon exposure to UV irradiation.

An “ideal” dispersion consists of a homogeneous suspension of primary particles. However, inorganic pigments are often incompatible with the resin in which they are incorporated, and this generally results in the failure of the pigment to uniformly disperse. Furthermore, a milling step may be required as dry pigments comprise a mixture of primary particles, aggregates, and agglomerates which must be wetted and de-aggregated before the production of a stable, pigment dispersion is obtained. The level of dispersion in a particular pigment-containing coating composition affects the application properties of the composition as well as the optical properties of the cured film. Improvements in dispersion result in improvements in gloss, color strength, brightness, and gloss retention.

The present composition optionally comprises at least one pigment or pigment dispersion in an amount ranging from 1-12% wt/wt, such as from 3 to 10% wt/wt, or 5 to 8% wt/wt.

G. Additional Agents

Compositions herein may optionally comprise adhesion promoters, corrosion inhibitors, curing boosters, and/or fillers to obtain desirable chemical and mechanical properties.

Compositions may further comprise additional fillers that are not necessarily nano-fillers, such as amorphous silicon dioxide prepared with polyethylene wax, synthetic amorphous silica with organic surface treatment, IRGANOX®, untreated amorphous silicon dioxide, alkyl quaternary bentonite, colloidal silica, acrylated colloidal silica, alumina, zirconia, zinc oxide, niobia, titania aluminum nitride, silver oxide, cerium oxides, and combinations thereof. Further, the average size of the filler particles is less than 10 micrometers, or less than 5 micrometers, or even less than 1 micrometer.

III. Methods of Using Compositions

Compositions described herein may be applied to fiber substrates to produce fiber products. Fiber substrates comprising the present compositions can be exposed to a source of actinic radiation, such as ultraviolet light, to effect curing. Thus, one aspect of the methods described herein is drawn to methods of manufacturing fiber products, said method comprising (a) providing a fiber substrate; (b) applying a composition to said fiber substrate to produce a fiber product; and (c) curing said fiber product, wherein said composition comprises:
(i) nano-fillers;
(ii) at least one photo-initiator;
(iii) at least one mono-functional monomer;
(iv) a surfactant;
(v) a diluent; and
(vi) optionally, a pigment dispersion and a second photo-initiator.
   A. Fiber Substrates

Any type of substrate that is, composed of, or derived from natural fibers is a suitable fiber substrate. In further or alternative embodiments, the fiber substrates are articles of manufacture. In further or alternative embodiments, the fiber substrates are part of articles of manufacture. Fiber substrates compatible with the present invention possess sufficient wicking action (capillary action) such that when applied, compositions will adhere to the fiber substrate.

Exemplary fiber substrates include all types of natural fabrics, such as cotton and wool fabrics; natural knits such as cotton and wool knits; paper of all thicknesses, such as tissue, envelopes, newspaper, magazine paper, book paper, business cards, writing paper and cardboard.

Prior to coating, paper substrates may optionally contain writing, such as pencil, staples, clips, perforations, and/or folds. Fabric substrates may optionally contain writing, folds, buttons, zippers, and the like. Fiber substrates may be of any size or shape, including but not limited to, square, rectangular, angular features, circular, etc.

Fiber substrates may be provided in any manner sufficient to facilitate applying the present compositions to the fiber substrate. In an embodiment, fiber substrates may be provided on a spindle or in a roll. In another embodiment, fiber substrates may be laid flatly on a conveyor belt or on a tray. In yet another embodiment, fiber substrates are hung on a moving line.

Fiber substrates encompass:
(a) various types of paper products, such as, but not limited to, stationary paper, writing paper, construction paper, cardboard paper, envelopes, paper bags, paper boxes, packages, paper labels, paper signs, newspaper, book paper, magazine paper, business cards, paper suitable for holding or containing food; freezerwrap, paper drinking cups, cardstock, and the like;
(b) various types of pulp containing products, such as drywall and wallboards, such as gypsum wallboards;
(c) various type of shipping materials, such as, but not limited to, envelopes, bags, boxes, packages, labels, and the like;
(d) various types of markers, such as, but not limited to, garden markers, underwater markers, soil markers, and the like;
(e) various types of natural fiber fabrics, such as, but not limited to, cotton, wool, linen, cashmere, hemp, rampie, silk, and the like;
(f) various types of natural fiber knits, such as, but not limited to, cotton, wool, linen, hemp, rampie, silk, and the like; and
(g) fiber substrates which have non-fiber components, such as, but not limited to, buttons, zippers, pins, staples, clips, rods, and the like
   B. Applying Compositions to Fiber Substrates

In an aspect of the methods for applying composition to fiber substrates, the present compositions are applied to fiber substrates so as to produce fiber products. Compositions may be applied to fiber substrates by means of spraying, brushing, rolling, dipping, blade coating, curtain coating or a combination thereof. For example, the means of spraying can include, but is not limited to, the use of a High Volume Low Pressure (HVLP) spraying systems, air-assisted/airless spraying systems, or electrostatic spraying systems.

In one embodiment, the compositions described herein are sprayed at high-pressure onto a fiber product, including pressures up to 25 psi, up to 30 psi, up to 35 psi, up to 40 psi, up to 45 psi, up to 50 psi, up to 55 psi, up to 60 psi, up to 65 psi, up to 70 psi, up to 80 psi, up to 90 psi, and up to 100 psi. Such high-pressure application of the compositions facilitates impregnation of the composition within the fiber product. In a further embodiment, following such an application of the compositions described herein, the paper is passed through rollers to assist in the distribution and/or the impregnation of the composition. In one embodiment, the rollers are hard acrylic rollers. In a further embodiment, the rollers produce a nice, even product. In one embodiment, the fiber product is paper, card stock, or cardboard. In a further embodiment, such a method allows the use of no more than 0.02 grams of composition per square inch of fiber product.

In an embodiment, the composition is forcibly applied or centrifugally applied onto the fiber substrate, such as by means of a rotating lens. In another embodiment, the lens is rotated by means of a spinner or reciprocator. Application of the composition by means of a rotating lens is advantageous over application by soaking, a wired down rod, or other drawing down methods. Application of the composition by means of a rotating lens produces fiber products having more desirable properties than fiber products where compositions are applied by soaking, wired down rod, and other drawing down methods.

The lens may be made of poly(methyl methacrylate), polyacrylamide, fluoropolymers, silicone polymers, CR-39 polycarbonate, or combinations thereof. In an embodiment, the lens is composed of polycarbonate, such as a polycarbonate contact lens. The lens can be rotated by any acceptable means of achieving rotation, including but not limited to, a spinner or reciprocator. In another embodiment, the lens is rotated by means of a reciprocator. The lens can rotate at any speed suitable to effect application to the fiber substrate. For example, the lens can be rotated at about 10, 20, 30, 40, 50, 60, 80, 100, 120, 150, or 200 rotations per minute (RPM). Alternatively, assemblages and means for effecting rotation may have standardized speed settings, e.g. slow, medium, high, etc. Compositions may be applied to fiber substrates under any standardized speed setting on an assemblage or means for effecting rotation, such as a spinner or reciprocator.

In an embodiment, a metered amount of the composition is delivered to the lens for application to the fiber substrate. Compositions may be delivered to the lens via a syringe or pump. In another embodiment, a syringe or pump that steadily delivers the composition to the lens is employed.

The amount of composition delivered to the lens depends on the type, shape, and size of the lens as well as the fiber substrate utilized. A larger amount of the composition will be applied to fiber substrates that are larger in size and have higher wicking action in comparison to smaller substrates that have lower wicking action. By way of example only, compositions may be applied to fiber substrates in an amount ranging from 0.01 to 2.0 grams per square inch of substrate, such as about 0.02-1.5, 0.05-1.0, or 0.05-0.1 g/in².

Fiber substrates may be coated with varying amounts of the present compositions. For example, fiber substrates may be partially coated or wholly coated with the present compositions.

In one embodiment, the compositions described herein are applied to both sides of a fiber product, using any of the methods described herein. In another embodiment, the compositions described herein are applied to one side of a fiber product, using any of the methods described herein; to prevent curling of the product following and/or during curing, the composition is preferably applied to the back side of the fiber product.

In an embodiment, a roll of paper substrate is drawn out and passed around a lens that is rotating by means of a reciprocator. In a further or alternative embodiment, the rotating lens comprises the composition and the composition is outwardly applied to the surface of the paper substrate via the rotating lens.

In further or alternative embodiments, the surfaces of the paper substrate become partially covered, or become fully covered by the uncured coating. In further or alternative embodiments, paper substrate with an uncured coated surface comprises non-fiber objects such as, but not limited to, metal objects, fiber glass objects, ceramic objects, glass objects, plastic objects, or combinations thereof. In further or alternative embodiments, the surfaces of non-fiber objects become partially covered, or become fully covered by the uncured coating.

In further or alternative embodiments, the composition is applied in a single application, or in multiple applications. In further or alternative embodiments, the composition is applied by a single lens or by multiple lenses. In further or alternative embodiments, multiple compositions are applied to the fiber substrate. In further or alternative embodiments, multiple compositions are applied simultaneously or sequentially to the fiber substrate.

In further or alternative embodiments, the composition is applied to fiber substrates at ambient temperature, or at temperatures higher or lower than ambient temperature.

An aspect of the invention is drawn to assemblages for manufacturing fiber products, wherein said assemblages comprise means for applying the present composition to fiber substrates. In an embodiment, assemblages comprise means for spraying, curtain coating, dipping, rolling, brushing, or throwing the present composition onto the surface of a fiber substrate. However, forcible application or centrifugal application by way of a lens is the most efficacious methods of application, and can be accomplished by delivering a measuring dosed of the composition via a rotating lens. While not wishing to be bound by a particular theory, it is believed that application of the composition by a rotating lens facilitates an impregnation of the composition into the fiber substrate and that impregnation of the composition imparts desirable characteristics: (a) retention of writability of pen and/or ink; (b) retention of print; and/or (c) retention of brightness.

C. Curing Compositions Comprising Fiber Substrates

An aspect described herein are methods, processes, devices and assemblages for curing fiber substrates comprising the present compositions. Curing can be achieved by exposure to heat or actinic radiation. The actinic radiation is selected from the group consisting of visible radiation, near visible radiation, ultra-violet (UV) radiation, and combinations thereof. Further, the UV radiation is selected from the group consisting of UV-A radiation, UV-B radiation, UV-C radiation, UV-D radiation, or combinations thereof.

Generally, UV-curable compositions are prepared using a single or mixture of photo-initiators sufficient to encompass all necessary frequencies of light. These are used to work with the lights or light pairs, arranged to ensure complete cure of an object. Polymerization, in particular acrylate double bond conversion and induction period, can be affected by the choice of oligomers, photo-initiators, inhibitors, and pigments, as well as UV lamp irradiance and spectral output. In comparison to clear coat formulations, the presence of pigments may make curing much more complex due to the absorption of the UV radiation by the pigment. Thus, the use of variable wavelength UV sources, along with matching of absorption characteristics of photo-initiators with UV source spectral output, allows for curing of pigmented formulations.

Light sources used for UV curing include arc lamps, such as carbon arc lamps, xenon arc lamps, mercury vapor lamps, tungsten halide lamps, lasers, the sun, sunlamps, and fluorescent lamps with ultra-violet light emitting phosphors. Medium pressure mercury and high pressure xenon lamps have various emission lines at wavelengths which are absorbed by most commercially available photo-initiators. In addition, mercury arc lamps can be doped with iron or gallium. Alternatively, lasers are monochromatic (single wavelength) and can be used to excite photo-initiators which absorb at wavelengths that are too weak or not available when using arc lamps. For instance, medium pressure mercury arc lamps have intense emission lines at 254 nm, 265 nm, 295 nm, 301 nm, 313 nm, 366 nm, 405/408 nm, 436 nm, 546 nm, and 577/579 nm. Therefore, a photo-initiator with an absorbance maximum at 350 nm may not be a efficiently excited using a medium pressure mercury arc lamp, but could be efficiently initiated using a 355 nm Nd:YVO4 (Vanadate) solid-state lasers. Commercial UV/Visible light sources with varied spectral output in the range of 250-450 nm may be used directly for curing purposes; however wavelength selection can be achieved with the use of optical bandpass or longpass filters. Therefore, as described herein, the user can take advantage of the optimal photo-initiator absorbance characteristics.

Regardless of the light source, the emission spectra of the lamp must overlap the absorbance spectrum of the photo-initiator. Two aspects of the photo-initator absorbance spectrum need to be considered. The wavelength absorbed and the strength of absorption (molar extinction coefficient). By way of example only, the photo-initiators HMPP (2-hydroxy-2-methyl-1-phenyl-propan-1-one) and TPO (diphenyl(2,4,6-trimethylbenzoyl)phosphine oxide) in DAROCUR® 4265 (from Ciba Specialty Chemicals 540 White Plains Road, Tarrytown, N.Y., U.S.A.) have absorbance peaks at 270-290 nm and 360-380 nm, while DAROCUR® 1173 (from Ciba Specialty Chemicals 540 White Plains Road, Tarrytown, N.Y., U.S.A.) have absorbance peaks at 245 nm, 280 nm, and 331 nm, while ESACURE® KTO-46 (from Lamberti S.p.A., Gallarate (VA), Italy) have absorbance peaks between 245 nm and 378 nm, and MMMP in IRGACURE® 907 (from Ciba Specialty Chemicals 540 White Plains Road, Tarrytown, N.Y., U.S.A.) absorbs at 350 nm and IRGACURE® 500 (which is a blend of IRGACURE® 184 (from Ciba Specialty Chemicals 540 White Plains Road, Tarrytown, N.Y., U.S.A.) and benzophenone) absorbs between 300 nm and 450 nm.

The addition of pigment to a formulation increases the opacity of the resulting coating and can have an effect on curing abilities. Furthermore, the added pigment can absorb the incident curing radiation and thereby affect the performance of the photo-initiator. Thus, the curing properties of opaque pigmented coatings can depend on the pigment present, individual formulation, irradiation conditions, and substrate reflection. Therefore consideration of the respective UV/vis absorbance characteristics of the pigment and the photo-initiator can be used to optimize UV curing of pigmented coatings. Generally, photo-initiators used for curing pigmented formulations have a higher molar extinction coefficient between the longer wavelengths (300 nm-450 nm) than those used for curing clear formulations. Although, the presence of pigments can absorb radiation both in the UV and visible light regions, thereby reducing absorption suitable for radiation curing, phosphine oxide type photo-initiators, for example but not limited to bis acylphosphine oxide, are effective in pigmented, including, by way of example only, black, UV-curable coating materials. Phosphine oxides also find use as photo-initiators for white coatings, and enable an effective through cure for the compositions described herein.

The mercury gas discharge lamp is the UV source most widely used for curing, as it is a very efficient lamp with intense lines UV-C (200-280 nm) radiation, however it has spectral emission lines in the UV-A (315-400 nm) and in the UV-B (280-513 nm) regions. The mercury pressure strongly affects the spectral efficiency of this lamp in the UV-A, UV-B and UV-C regions. Furthermore, by adding small amounts (doping) of silver, gallium, indium, lead, antimony, bismuth, manganese, iron, cobalt and/or nickel to the mercury as metal iodides or bromides, the mercury spectrum can be strongly changed mainly in the UV-A, but also in the UV-B and UV-C regions. Doped gallium gives intensive lines at 403 and 417 nm; whereas doping with iron raises the spectral radiant power in the UV-A region of 358-388 nm by a factor of 2, while because of the presence of iodides UV-B and UV-C radiation are decreased by a factor of 3 to 7. As discussed above, the presence of pigments in a coating formulation can absorb incident radiation and thereby affect the excitation of the photo-initiator. Thus, it is desirable to tailor the UV source used with the pigment dispersions and the photo-initiator, photo-initiator mixture or photo-initiator/co-initiator mixture used. For instance, by way of example only, an iron doped mercury arc lamp (emission 358-388 nm) is ideal for use with photo-initiator ESACURE® KTO-46 (from Lamberti S.p.A., Gallarate (VA), Italy) (absorbance between 245 and 378 nm).

Multiple lamps with a different spectral characteristics, or sufficiently different in that there is some spectral overlap, can be used to excite mixtures of photo-initiator or mixtures of photo-initiators and co-initiators. For instance, by way of example only, the use of a iron doped mercury arc lamp (emission 358-388 nm) in combination with a pure mercury arc lamp (emission 200-280 nm). The order in which the excitation sources are applied can be adventitiously used to obtain enhanced coating characteristic, such as, by way of example only, hardness, smoothness, shine, adhesion, abrasion resistance, scratch resistance, impact resistance and corrosion resistance. Initial exposure of the coated surface with the longer wavelength source is beneficial, as it traps the nano-filler particle in place and initiates polymerization near the surface, thereby imparting a smooth and adherent coating. Following this with exposure to the higher energy, shorter wavelength radiation enables for a fast cure of the remaining film that has been set in place by the initial polymerization stage.

The time of exposure to each lamp type can be manipulated to enhance the curing of the compositions described herein. One approach used for curing of the compositions described herein used to coat surfaces of wooden objects, is to expose the coated surface to the longer wavelength doped mercury arc lamps for a shorter time than exposure to the shorter wavelength mercury arc lamp. However, this exposure scheme may cause the cured coatings to wrinkle/crinkle. Therefore, other exposure schemes involve identical exposure time for both the short wavelength mercury arc lamp, and the longer wavelength doped mercury arc lamps, or alternatively the exposure time to the longer wavelength doped mercury arc lamp can be longer than the time of exposure for the short wavelength mercury arc lamps. In an embodiment, fiber substrates comprising the present compositions are exposed to a mercury arc lamp.

In further or alternative embodiments, the time period for exposing fiber products to actinic radiation is less than 2 minutes. In further embodiments, the time period for exposing fiber products to actinic radiation is less than 1 minute. In further embodiments, the time the time period for exposing fiber products to actinic radiation is less than 15 seconds.

Fiber products can optionally be exposed to two sources of actinic radiation. In further or alternative embodiments, the time between the first actinic radiation step and the second actinic radiation step is less than 2 minutes. In further embodiments, the time between the first actinic radiation step and the second actinic radiation step is less than 1 minute. In further embodiments, the time between the first actinic radiation step and the second actinic radiation step is less than 15 seconds.

In further or alternative embodiments, the length of time of the first actinic radiation step is shorter than the length of time of the second actinic radiation step. In further or alternative embodiments, the length of time of the first actinic radiation step is longer than the length of time of the second actinic radiation step. In further or alternative embodiments, the length of time of the first actinic radiation step is identical to the length of time of the second actinic radiation step.

Embodiments include fiber products comprising the present compositions which exhibit at least one, two, or three of the following characteristic upon curing: (a) retention of writability of pen and/or ink; (b) retention of print; and/or (c) retention of brightness.

In a further or alternative embodiment, cured fiber products exhibit at least one, two, three, or four of the following characteristics after exposure to water for at least 1 day: (a) retention of structural strength; (b) retention of ink or pencil writing; (c) retention of print; and/or (d) retention of brightness.

An aspect of the invention is drawn to assemblages for manufacturing fiber products, wherein said assemblages comprise means for curing fiber substrates comprising the present composition. In an embodiment, assemblages comprise an irradiation station that includes at least one light capable of providing actinic radiation selected from the group consisting of visible radiation, near visible radiation, ultra-violet (UV) radiation, and combinations thereof. In further or alternative embodiments, the irradiation station includes at least one light source capable of providing actinic radiation selected from the group consisting of UV-A radiation, UV-B radiation, UV-B radiation, UV-C radiation, UV-D radiation, or combinations thereof.

D. Assemblages, Process Lines, and Factories

In a further aspect described herein are methods for producing the present compositions are presented and involve adding the components, for instance, by way of example only, at least one nano-filler, at least one photo-initiator, at least one mono-functional monomer, at least one surfactant, a diluent, and optionally at least one pigment dispersion and a second photo-initiator, and using a means for mixing the components together to form a smooth composition. In further or alternative embodiments, the composition may be mixed in or transferred to a suitable container, such as, but not limited to, a can.

In another aspect are assemblages for applying the composition to at least a portion of a surface of a fiber substrate comprising a means for applying the present composition to the substrate; a means for irradiating the fiber substrate comprising the applied composition with a source of actinic radiation so as to wholly or partially cure the applied surface. Fiber products produced by the present methods and assemblages exhibit at least one, two, or three of the following characteristis: (a) retention of writability of pen and/or ink; (b) retention of print; and/or (c) retention of brightness. Additionally, fiber products produced by the present methods and assemblages exhibit at least one, two, three, or four of the following characteristics after exposure to water for at least 1 day: (a) retention of structural strength; (b) retention of ink or pencil writing; (c) retention of print; and/or (d) retention of brightness.

In an embodiment, assemblages comprise means for mixing components of the present compositions. In a further or alternative embodiment, assemblages comprise means for providing a fiber substrate. In a further or alternative embodiment, assemblages comprise means for applying the present composition to a fiber substrate. In a further or alternative embodiment, assemblages comprise means for curing fiber substrates comprising applied compositions.

Fiber substrates may be provided in any manner sufficient to facilitate applying the present compositions to the fiber substrate. In an embodiment, fiber substrates are provided on a spindle or in a roll. In another embodiment, fiber substrates may be laid flatly on a conveyor belt or on a tray. In yet another embodiment, fiber substrates are hung on a moving line.

Means for curing the fiber substrates may comprise irradiating substrates comprising the present composition so as to partially or completely cure the surface at an irradiation station. In an embodiment, irradiation and curing is accomplished at a single station so as to not require the transport of the object. In still a further embodiment, the means for applying the composition is located at an application station, wherein the object must be moved from the application station to the irradiation station. In yet a further embodiment, such assemblages further comprise a means for moving the object from the application station to the irradiation station. In still yet a further embodiment, the means for moving comprises a conveyer belt.

In further or alternative embodiments, the irradiation station comprises a means for limiting the exposure of actinic radiation to the application station. In yet further or alternative embodiment, assemblages further comprise a means for rotating the substrate around at least one axis. In yet further or alternative embodiment, assemblages further comprise a mounting station wherein the substrate to be applied with the composition is attached to a movable unit. In further embodiments, the movable unit is capable of rotating the substrate around at least one axis. In further or alternative embodiments, the movable unit is capable of moving the substrate from the application station to the irradiation station.

In still further or alternative embodiments, such assemblages further comprise a removal station wherein the completely cured fiber product is removed from the movable unit. In further embodiments, the completely cured fiber product does not require cooling prior to removal from the movable unit.

In further or alternative embodiments, the application station further comprises a means for reclaiming composition that is non-adhering to the surface of the fiber substrate. In still further embodiments, the reclaimed composition is subsequently applied to a different substrate.

In further or alternative embodiments, the assemblage comprise a source of actinic radiation selected from the group consisting of visible radiation, near visible radiation, ultra-violet (UV) radiation, and combinations thereof. In further or alternative embodiments, the assemblage comprise multiple sources of actinic radiation. In further or alternative embodiments, the irradiation station includes an arrangement of mirrors.

In further embodiments, processes further comprise attaching the fiber substrate to a rotatable spindle prior to the application step. In further or alternative embodiments, such processes further comprise moving the conveying means after attaching the object to the rotatable spindle so as to locate the object near an application station. In further embodiments, such processes further comprise applying the present composition at the application station as the spindle holding the object rotates. In further embodiments, the conveying means comprises a conveyer belt.

In further or alternative embodiments, the-irradiation station comprises a curing chamber containing a first actinic radiation source and a second actinic radiation source.

In further embodiments, such processes further comprise moving the completely cured product via the conveying means outside the curing chamber wherein the product is packed for storage or shipment.

In further or alternative embodiments, the irradiation station includes an arrangement of mirrors such that the applied surface is cured in three dimensions. In further or alternative embodiments, the irradiation station includes an arrangement of light sources such that the coated surface is cured in three dimensions. In further embodiments, each light source emits different spectral wavelength ranges. In further embodiments, the different light sources have partially overlapping spectral wavelength ranges.

In another aspect are production lines for applying at least a portion of a surface of a fiber substrate with the present composition comprising a process which comprises attaching the substrate onto a conveying means; applying the present composition at an application station onto the surface of the fiber substrate; moving the applied substrate via the conveying means to an irradiation station; irradiating and partially or wholly curing the applied surface at the irradiation station with actinic radiation; wherein the fiber product upon curing exhibit at least one, two, or three of the following characteristics: (a) retention of writability of pen and/or ink; (b) retention of print; and/or (c) retention of brightness. Alternatively or in conjunction, fiber products produced by the present production lines exhibit at least one, two, three, or four of the following characteristics after exposure to water for at least 1 day: (a) retention of structural strength; (b) retention of ink or pencil writing; (c) retention of print; and/or (d) retention of brightness.

In another aspect are facilities or factories for producing fiber products comprising at least one process line for applying at least a portion of a surface of a fiber substrate with the present composition comprising a process which comprises attaching the substrate onto a conveying means; at least one process line for applying the present composition at an application station onto the surface of the fiber substrate; at least one process line for moving the applied substrate via the conveying means to an irradiation station; and at least one process line for irradiating and partially or wholly curing the applied surface at the irradiation station with actinic radiation; wherein the fiber product upon curing exhibit at least one, two, or three of the following characteristics: (a) retention of writability of pen and/or ink; (b) retention of print; and/or (c) retention of brightness. Alternatively or in conjunction, fiber products produced by the present production lines exhibit at least one, two, three, or four of the following characteristics after exposure to water for at least 1 day: (a) retention of structural strength; (b) retention of ink or pencil writing; (c) retention of print; and/or (d) retention of brightness.

E. Fiber Products

Fiber products provided herein are fiber substrates comprising the present compositions. In further or alternative embodiments, the entire surface or just a portion of the surface of fiber products comprise the present compositions. In further or alternative embodiments, the present composition may be sparingly applied or heavily applied to the fiber substrate. In further or alternative embodiments, fiber products that comprise the present compositions may be uncured, partially cured, or completely cured.

In an aspect of the invention, the present composition upon curing provides at least one, two, or three of the following characteristics to the fiber product: (a) retention of writability of pen and/or ink; (b) retention of print; and/or (c) retention of brightness. In an embodiment, fiber product exhibits at least one, two, or three of the following characteristics: (a) retention of writability of pen and/or ink; (b) retention of print; and/or (c) retention of brightness.

In another aspect of the invention, the present composition upon curing provides at least one, at least two, at least three, or at least four of the following characteristics to the fiber product after exposure to water: (a) retention of structural strength; (b) retention of ink or pencil writing; (c) retention of print; and/or (d) retention of brightness.

In further or alternative embodiments, fiber product exhibits the following characteristics after exposure to water for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 40, 45, 50, 55, and 60 days: (a) retention of structural strength; (b) retention of ink or pencil writing; (c) retention of print; and/or (d) retention of brightness.

In further or alternative embodiments, fiber product exhibits the following characteristics after exposure to water for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 40, 45, 50, 55, and 60 days: (a) retention of structural strength; (b) retention of ink or pencil writing; (c) retention of print; and/or (d) retention of brightness.

Exposure to water can constitute partial or complete exposure to water. Alternatively, exposure to water can include exposure to moisture, such as mist, fog, and pressurized water vapor. Alternatively, exposure to water can constitute exposure to water-containing weather, such as rain, drizzle, snow, sleet, fog, hail, and the like. Alternatively, exposure to water can constitute partial or complete submersion of an object in water. Alternatively, exposure to water can be continuous, consecutive, or intermittent. For example, objects exposed to water can be submerged underwater or laying in a pool of water.

Exposure to any type of water is contemplated as being within the scope of the invention. Pure water, ionized water, de-ionized water, filtered water, salt water, rain water, mineral water, river water, mud water, enriched water, tap water, and spring water are all embraced within the invention.

F. Examples of Cured Paper Products

In one non-limiting example, newspaper-grade paper is impregnated/coated and cured with the compositions described herein using the methods described herein. The newspaper is then printed using standard techniques. The resulting newspaper retains (a) structural strength; (b) print; and (d) brightness, even upon continuous exposure to water for several days or weeks. A similar procedure produces magazine, books (including cookbooks), maps, field guides, business cards, envelopes, packaging material and cardboard with similar properties. In a further embodiment, the resulting fiber product is paper suitable for further printing using a standard laser printer, ink-jet printer, or typewriter. Further, the applied print can be black ink, white ink or any color ink (and combinations thereof). The resulting printed paper product retains (a) structural strength; (b) print; and (d) brightness, even upon continuous exposure to water for several days or weeks.

In another non-limiting example, the compositions described herein are coated/impregnated as described herein onto food grade paper as described herein and the resulting product used to wrap a food product. The resulting food grade paper retains (a) structural strength; (b) print; and (d) brightness, even upon continuous exposure to the food product for several days or weeks. By way of example only, a food product includes water, drinks, ice cream, beer, wine, soup, and coffee.

In another non-limiting example, the compositions described herein are coated/impregnated as described herein onto paper as described herein and the resulting product used as a rollable, portable, dry-erase board. That is, dry-erase markers can readily write on the paper product, and the resulting writing can be erased using a standard dry-erase eraser. The rollable, portable, dry-erase board can be used multiple times without loss of structural strength, writability or durability.

In another non-limiting example, the compositions described herein are coated/impregnated as described herein onto a shower curtain as described herein and the resulting product used as a shower curtain. The resulting shower curtain resists the growth of mold and mildew.

III. Testing the Fiber Products

The present compositions possess excellent durability and are suitable for surfaces of fiber products which encounter physical wearing or exposure to various weather conditions. Various mechanical properties of solid coatings and the various testing methods for them is described in “Mechanical Properties of Solid Coatings” Encyclopedia of Analytical Chemistry, John Wiley & Sons, 2000, which is herein incorporated by reference in its entirety. Descriptions for the following tests are provided by way of example only.

For example, the compositions and methods described herein provide an improved cured product that exhibits improvement in at least one of the following properties: (a) retention of writability of pen and/or ink; (b) retention of print; and (c) retention of brightness.

For example, the compositions and methods described herein provide an improved cured product that exhibits improvement in at least one of the following properties: (a) retention of structural strength; (b) retention of ink or pencil writing; (c) retention of print; and (d) retention of brightness.

Retention of brightness prevents discoloration, such as darkening or yellowing, of a material. Representative tests for determining retention of brightness include spectrophotometric tests, such as optical absorption test for brightness (wavelength=457 nm) and/or luminance (wavelength=555 nm), for example.

Retention of ink or pencil writing refers to the ability of ink or pencil writing to be retained on a material. Retention of ink or pencil writing prevents bleeding, fading, and/or streaking on a material. Representative tests for determining retention of ink or pencil writing include spectrophotometric tests, such as the Ink Elimination (IE) test and the Effective Residual Ink Concentration (ERIC) test, for example

Retention of print refers to the ability of print to be retained on a material. Representative prints include various ink prints, such as labels, logos, and the like. Retention of print prevents bleeding, fading, and/or streaking on a material. Representative tests for determining retention of print include various spectral photometric tests.

Retention of structural strength refers to the ability of a material to retain its physical and structural integrity, strength, or durability. Retention of structural strength prevents tearing, ripping, or breaks. Representative mechanical tests for determining retention of structural strength include manual inspection, folding endurance, and tensile strength, for example. Spectral photometric tests may also be employed to determine retention of structural strength.

Retention of writability of pencil and/or ink refers to the ability of a material to retain its ability to be written upon by any type of pencil or any source of ink, such as a pen or printer. Writability depends on the absorbency of a material.

Resistance to the growth of mold, bacteria, and/or fungus refers to the ability of the material to inhibit or slow down the growth of these of mold, bacteria, and/or fungus. This characteristic can be tested by streaking a mold, bacteria, and/or fungus on the coating and/or cured fiber product and comparing the growth of the mold, bacteria, and/or fungus relative to an uncoated and/or uncured fiber product. The coated and cured fiber products described herein, in addition to retaining structural integrity and/or structural strength, also resist the growth of mold, bacteria, and/or fungus even when the fiber product is exposed to mold, bacteria, and/or fungus in water. EXAMPLES

### Example 1

### Formulation for Clear Composition

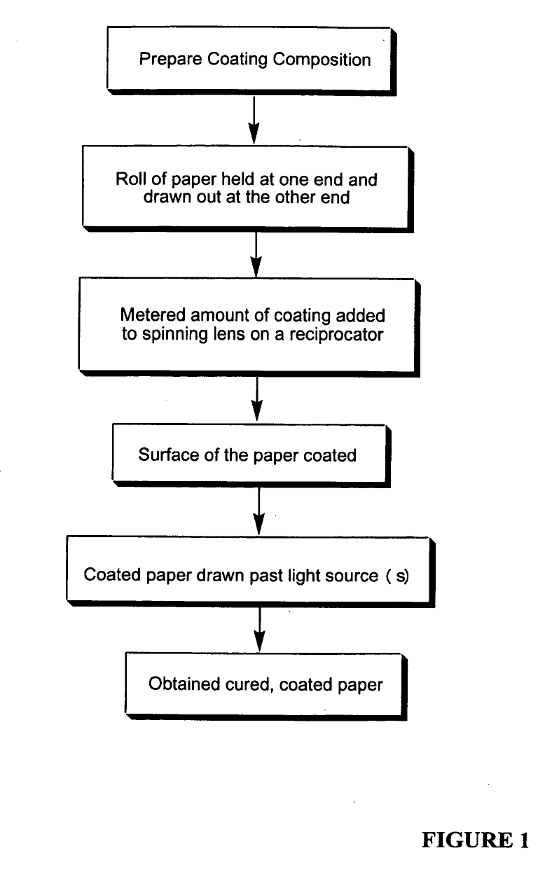

As illustrated in FIG. 1, an embodiment for a clear composition is prepared by mixing 21.45% tetrahydofurfuryl acrylate; 11.98% isobornyl acrylate; 12.56% 1,4-butanediol dimethacrylate; 13.62% 2-phenoxyethyl acrylate; 34.91% Nanocryl C-155 (available from Hansiechemie, Germany); 2.00% Irgacure 500 (available from Ciba Specialty Chemicals); 3.43% Irgacure 184 (available from Ciba Specialty Chemicals); and 0.05% Tego Rad 2100 (available from Tego Chemie). These components are thoroughly mixed by the helical mixer until a homogeneous composition is produced.

Additional embodiments for clear compositions are prepared by mixing the following components:

| | | |
|---|---|---|
| Tetrahydrofurfuryl | 11-31 | wt/wt % |
| Acrylate | | |
| Isobornyl Acrylate | 2-22 | wt/wt % |
| 1,4-Butanediol | 3-40 | wt/wt % |
| Dimethacrylate | | |
| 2-Phenoxyethyl | 4-40 | wt/wt % |
| Acrylate | | |
| Nanocryl C-155 | 25-50 | wt/wt % |
| Irgacure 184 | 2-10 | wt/wt % |
| Irgacure 500 | 0.5-10 | wt/wt % |
| TEGO ® Rad 2100 | 0.01-2.0 | wt/wt % |

### Example 2

### Formulation for Pigmented Composition

An embodiment for a pigmented composition is prepared by mixing 21.45% tetrahydofurfuryl acrylate; 11.98% isobornyl acrylate; 12.56% 1,4-butanediol dimethacrylate; 13.62% 2-phenoxyethyl acrylate; 34.91% Nanocryl C-155 (available from Hansiechemie, Germany); 2.00% Irgacure 500 (available from Ciba Specialty Chemicals); 3.43% Irgacure 184 (available from Ciba Specialty Chemicals); 0.05% Tego Rad 2100 (available from Tego Chemie); 1-12% PC 9003, and 0.5-5.0% Lucerin TPO. These components are thoroughly mixed by the helical mixer until a homogeneous composition is produced.

Additional embodiments for pigmented compositions are prepared by mixing the following components:

| | | |
|---|---|---|
| Tetrahydrofurfuryl | 11-31 | wt/wt % |
| Acrylate | | |
| Isobornyl Acrylate | 2-22 | wt/wt % |
| 1,4-Butanediol | 3-40 | wt/wt % |
| Dimethacrylate | | |
| 2-Phenoxyethyl | 4-40 | wt/wt % |
| Acrylate | | |
| Nanocryl C-155 | 25-45 | wt/wt % |
| Irgacure 184 | 2-6 | wt/wt % |
| Irgacure 500 | 0.5-4.0 | wt/wt % |
| TEGO ® Rad 2100 | 0.01-2.0 | wt/wt % |
| PC 9003 | 1-12 | wt/wt % |
| Lucerin TPO | 0.5-5 | wt/wt % |

### Example 3

### Procedure Used for Making Clear Compositions

A further embodiment is the procedure used for making the present compositions. The components of the composition are mixed under air, as the presence of oxygen prevents premature polymerization. It is desired that exposure light be kept to a minimum, in particularly the use of sodium vapor lights should be avoided. However, the use of darkroom lighting may be an option. The components used in the manufacture of the composition which come in contact with monomers and coating mixture, such as mixing vessels and mixing blades, should be made of stainless steel or plastic, preferably polyethylene or polypropylene. Polystyrene and PVC should be avoided, as the monomers and mixture will dissolve them. In addition, contact of the monomers and mixture with mild steel, alloys of copper, acids, bases, and oxidizers should be avoided. Furthermore, brass fittings must be avoided, as they will cause premature polymerization or gelling. Adequate mixing of the composition can be obtained after 1-3 hours using a ⅓ horse power (hp) mixer and a 50 gallon cylindrical tank. Smaller quantities, up to 5 gallons, can be adequately mixed after 3 hours using a laboratory mixer ( 1/15- 1/10 hp). Round walled vessels are desired as this avoids accumulation of materials in corners and any subsequent problems associated with incomplete mixing. Another parameter is that the mixers blades should be placed off of the bottom of the mixing vessel, at a distance of one half of the diameter of the mixer. The monomers are added to the mixing vessel first, and if necessary the monomers are gently warmed to aid in handling. Monomers should not be heated over 120° F., therefore if warming is needed the use of a temperature controlled heating oven or heating mantle is recommended. No heating is necessary for the formation of clear coatings. Band heaters should be avoided. Colloidal suspensions are added next, in any order, followed by any ester/monomer adhesion promoters. Photo-initiators are added last to ensure that the time the complete composition is exposed to light is minimized. With the mixing vessel shielded from light exposure the mixing is then carried out after all the components are added. After mixing, there are air bubbles present and the composition may appear cloudy. These bubbles rapidly dissipate, leaving a homogeneous composition. As a final step, prior to removing the coating composition from the mixing vessel, the bottom of the mixing vessel is scraped to see if any undissolved material is present. This is done as a precaution to ensure thorough mixing has taken place. If the composition is thoroughly mixed then the coating composition is filtered through a 1 micron filter using a bag filter. The composition is then ready for use.

### Example 4

### Procedure Used for Making Pigmented Compositions

A further embodiment is the manufacture procedure for pigmented compositions. Here a mixer of sufficient power and configuration is used to create laminar flow and efficiently bring the pigment dispersions against the blades of the mixer. For small laboratory quantities below 400 mL, a laboratory mixer or blender is sufficient, however for quantities of up to half of a gallon a 1/15- 1/10 hp laboratory mixer can be used, but mixing will take several days. For commercial quantities, a helical or saw-tooth mixer of at least 30 hp with a 250 gallon round walled, conical bottomed tank may be used. To make a pigmented composition a clear composition is mixed first, see Example 3. The pigment dispersion mixtures are premixed prior to addition to the clear composition as this ensures obtaining the correct color. The premixing of the pigments dispersions is easily achieved by shaking the pigments dispersion in a closed container, while wearing a dust mask. The fillers, the premixed pigments/pigment dispersions, and solid photo-initiator are then added to the clear composition and mixed for 1½ to 2 hours. Completeness of mixing is determined by performing a drawdown and checking for undissolved pigment. This is accomplished by drawing off a small quantity of the pigmented mixture from the bottom of the mixing tank and applying a thin coating onto a surface. This thin coating is then examined for the presence of any pigment which had not dissolved. The mixture is then run through a 100 mesh filter. A thoroughly mixed pigmented composition will show little or no un-dissolved pigment.

### Example 5

### Process for Applying Compositions to the Surface of Paper and Curing the Paper

A. Applying Composition to a Sheet of Paper

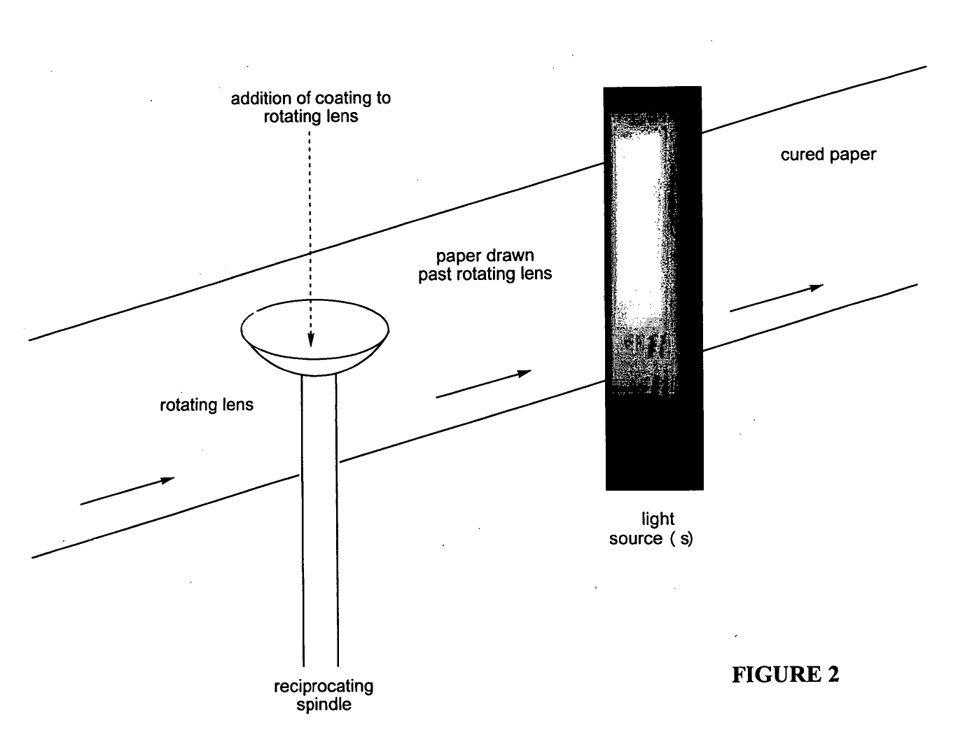

An embodiment for applying the composition as described in Examples 1 and 2 to the surface of a sheet of paper is illustrated in FIG. 2. The sheet of paper is positioned proximately to a rotating lens that contains the composition. In this embodiment, the lens is rotated in a counter-clock wise direction by a rotating spindle. As the lens rotates, the composition is thrown onto the sheet of paper. A metered amount of the composition is continuously added to the lens, via a syringe or pump, until the surface of the paper is covered with the composition.

In an embodiment, an 8.5″×11″ sheet of stationary paper was heavily coated with the composition of Example 1 and weighed. The difference in weight between the coated paper and an uncoated paper was calculated. An amount of 0.057 g of composition was applied per square inch of the paper, which corresponded to about 5.55 g of composition for an 8.5″×11″ sheet.

In an embodiment, an 8.5″×11″ sheet of stationary paper was coated with a smaller amount of the composition of Example 1 and weighed. The difference in weight between the coated paper and an uncoated paper was calculated. An amount of 0.04425 g of composition was applied per square inch of the paper, which corresponded to about 4.14 of composition for an 8.5″×11″ sheet.

In an embodiment, an 8.5″×11″ sheet of stationary paper was coated with the composition of Example 2, wherein said composition comprised 9.3% white pigment dispersion. The difference in weight between the coated paper and an uncoated paper was calculated. An amount of 0.04025 g of composition was applied per square inch of the paper, which corresponded to about 3.74 g of composition for an 8.5″×11″ sheet. Other sheets having less composition applied to the surface was also obtained.

B. Applying Composition to a Roll of Paper

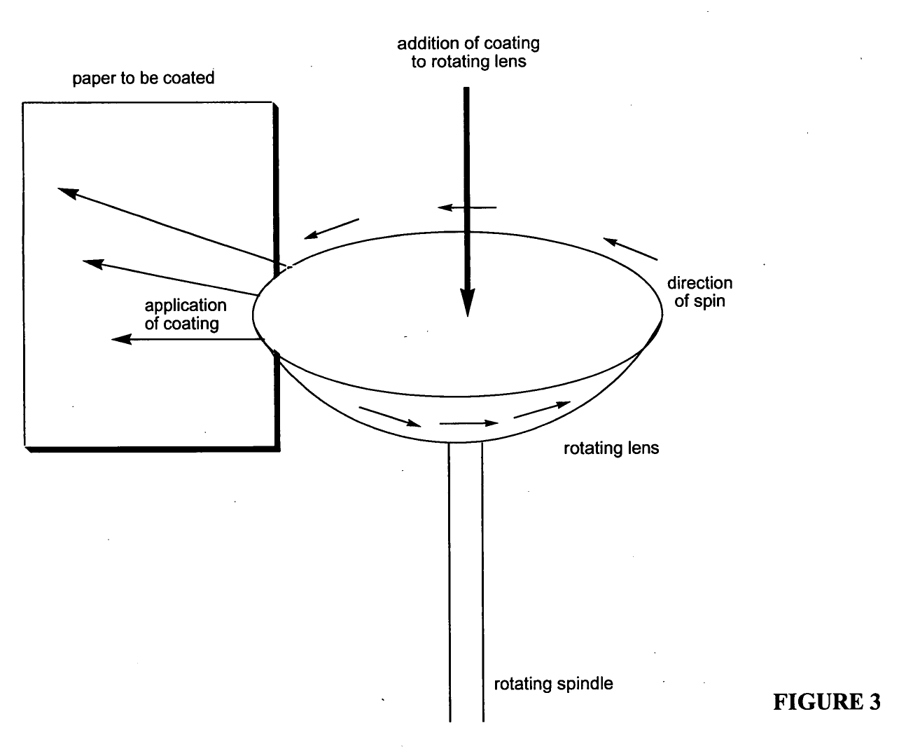

An embodiment for applying the composition as described in Examples 1 and 2 to the surface of paper in a roll is illustrated in FIG. 3. The roll of paper is positioned proximately to a rotating lens and drawn past the lens. The lens contains the composition and a metered amount of the composition is continuously added to the lens, via a syringe or pump. The lens can rotate in a clockwise or counter-clock wise direction by a rotating spindle. As the-lens rotates, the composition is thrown onto the roll of paper. A metered amount of the composition is continuously added to the lens and applied to the paper until the surface of the paper is covered with the composition.

C. Curing Paper Coated with Compositions

After applying the composition to the sheet of paper or roll of paper, paper is then exposed to a source of UV radiation to effect curing. As illustrated in FIG. 3, the roll of paper comprising the composition is drawn past the UV source.

For compositions of Example 1, exposure to the coated paper to one mercury arc lamp is sufficient to effect curing. For compositions of Example 2, exposure to the coated paper to two mercury arc lamps is sufficient to effect curing, where one lamp can be a mercury arc lamp and the other lamp can be a mercury arc lamp doped with iron, to ensure proper curing. Generally, the time of exposure to the doped mercury arc lamp is less than the time of exposure to the pure mercury arc lamp. Both lamps are turned off and the cured paper is then removed.

### Example 6

### Representative Properties of Cured Paper

Cured paper made according to Example 5 exhibited comparable writability for both pencil and ink as paper not comprising the composition. The presence of the composition did not impair the ability of pencil or ink to be absorbed onto the cured paper. Cured paper made according to Example 5 exhibited comparable brightness and luminosity in comparison to paper not comprising the composition. In comparison to paper not comprising the composition, printed paper cured according to Example 5 retained the print after the composition was applied and after the paper was cured.

Both ink and pencil were written on cured paper made according to Example 5, and was left to soak in a tub of tap water at ambient temperature for 1, 2, 3, 4, 5, 6, 7, 8, 9, 10, 11, 12, 13, 14, 15, 16, 17, 18, 19, 20, 21, 25, 30, 35, 40, 45, 50, 55, and 60 consecutive days. Based upon visual inspection, the ink and pencil writing was retained on the cured paper after soaking in water for 1, 2, 3, 4, 5, 6, 7, 8, 9, 10, 11, 12, 13, 14, 15, 16, 17, 18, 19, 20, 21, 25, 30, 35, 40, 45, 50, 55, and 60 consecutive days. No apparent bleeding, streaking, or fading of the ink or pencil writing had occurred.

Based upon visual inspection, the brightness and luminosity of the cured paper was retained after soaking in water for 1, 2, 3, 4, 5, 6, 7, 8, 9, 10, 11, 12, 13, 14, 15, 16, 17, 18, 19, 20, 21, 25, 30, 35, 40, 45, 50, 55, and 60 consecutive days. No apparent discoloration, molding, or yellowing had occurred.

Based upon visual and physical inspection, the structural strength of the cured paper was retained after soaking in water for 1, 2, 3, 4, 5, 6, 7, 8, 9, 10, 11, 12, 13, 14, 15, 16, 17, 18, 19, 20, 21, 25, 30, 35, 40, 45, 50, 55, and 60 consecutive days. No apparent tearing, ripping, or breakage had occurred.

Based upon visual inspection, the print of the cured paper was retained after soaking in water for 1, 2, 3, 4, 5, 6, 7, 8, 9, 10, 11, 12, 13, 14, 15, 16, 17, 18, 19, 20, 21, 25, 30, 35, 40, 45, 50, 55, and 60 consecutive days. No apparent bleeding, streaking, or fading of the print had occurred.

A commercial “Envelope X-RAY Spray,” which temporarily turns opaque paper translucent to allow a user to view the contents of an envelope without ever opening it, was applied to cured paper produced by methods presented herein. The cured paper did not turn translucent after application of the “Envelope X-RAY Spray.” In contrast, paper not comprising the composition turned translucent approximately 30 seconds after application of the spray. Moreover, cured paper presented herein is able to resist absorption of organic solvents, such as alcohol and methyl ethyl ketone.

While the invention has been described in connection with an embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A composition comprising:
(a) nano-fillers selected from SiO₂ or Al₂O₃;
(b) at least one photo-initiator comprising an α-hydroxyketone;
(c) at least one monofunctional monomer comprising an acrylate;
(d) a diluent for oligomers, said diluent comprising an acrylate;
(e) a surfactant comprising a cross-linkable, silicone acrylate; and
(f) optionally, a pigment dispersion and a second photoinitiator comprising benzoyl diaryl phosphine oxide.

2. The composition of claim 1, wherein said nanoparticles have an average diameter of about 20 nm and a particle size distribution ranging from about 5 nm to about 30 nm.

3. The composition of claim 1, wherein said photo-initiator of (b) comprises 1-hydroxy-cyclohexyl-phenyl-ketone.

4. The composition of claim 1, wherein said photo-initiator of (b) comprises Irgacure 184 and benzophenone.

5. The composition of claim 1, wherein said monofunctional monomer of (c) comprises tetrahydrofurfuryl acrylate.

6. The composition of claim 1, wherein said monofunctional monomer of (c) comprises 1,4-butanediol dimethacrylate.

7. The composition of claim 1, wherein said monofunctional monomer of (c) comprises 2-phenoxyethyl acrylate.

8. The composition of claim 1, wherein said monofunctional monomer of (c) comprises tetrahydrofurfuryl acrylate, 1,4-butanediol dimethacrylate, and 2-phenoxyethyl acrylate.

9. The composition of claim 1, wherein said diluent of (d) comprises isobornyl acrylate.

10. The composition of claim 1, corresponding to:

| | | |
|---|---|---|
| Tetrahydrofurfuryl | 11-31 | wt/wt % |
| Acrylate | | |
| Isobornyl Acrylate | 2-22 | wt/wt % |
| 1,4-Butanediol | 3-40 | wt/wt % |
| Dimethacrylate | | |
| 2-Phenoxyethyl | 4-40 | wt/wt % |
| Acrylate | | |
| Nanocryl C-155 | 25-50 | wt/wt % |
| Irgacure 184 | 2-10 | wt/wt % |
| Irgacure 500 | 0.5-10 | wt/wt % |
| TEGO ® Rad 2100 | 0.01-2.0 | wt/wt % |

11. The composition of claim 1, corresponding to:

| | | |
|---|---|---|
| Tetrahydrofurfuryl | 11-31 | wt/wt % |
| Acrylate | | |
| Isobornyl Acrylate | 2-22 | wt/wt % |
| 1,4-Butanediol | 3-40 | wt/wt % |
| Dimethacrylate | | |
| 2-Phenoxyethyl | 4-40 | wt/wt % |
| Acrylate | | |
| Nanocryl C-155 | 25-45 | wt/wt % |
| Irgacure 184 | 2-6 | wt/wt % |
| Irgacure 500 | 0.5-4.0 | wt/wt % |
| TEGO ® Rad 2100 | 0.01-2.0 | wt/wt % |
| PC 9003 | 1-12 | wt/wt % |
| Lucerin TPO | 0.5-5 | wt/wt % |

12. The composition of claim 10, corresponding to:

| | | |
|---|---|---|
| Tetrahydrofurfuryl | 21.45 | wt/wt % |
| Acrylate | | |
| Isobornyl Acrylate | 11.98 | wt/wt % |
| 1,4-Butanediol | 12.56 | wt/wt % |
| Dimethacrylate | | |
| 2-Phenoxyethyl | 13.62 | wt/wt % |
| Acrylate | | |
| Nanocryl C-155 | 34.91 | wt/wt % |
| Irgacure 184 | 3.43 | wt/wt % |
| Irgacure 500 | 2.00 | wt/wt % |
| TEGO ® Rad 2100 | 0.05 | wt/wt % |

13. A paper product comprising (a) a paper substrate; and (b) a composition comprising:
(i) nano-fillers selected from SiO₂ or Al₂O₃;
(ii) at least one photo-initiator comprising an α-hydroxyketone;
(iii) at least one monofunctional monomer comprising an acrylate;
(iv) a diluent for oligomers, said diluent comprising an acrylate;
(v) a surfactant comprising a cross-linkable, silicone acrylate; and
(vi) optionally, a pigment dispersion and a second photoinitiator comprising benzoyl diaryl phosphine oxide.

14. The paper product of claim 13, wherein said composition is impregnated into the surface of the paper substrate.

15. The paper product of claim 13, wherein said composition is cured in and/or on to the paper substrate.

16. The paper product of claim 15, wherein said paper product, after exposure to water, exhibits at least one of the following characteristics selected from the group consisting of: (a) retention of structural strength; (b) retention of ink or pencil writing; (c) retention of print; and (d) retention of brightness.

17. The paper product of claim 16, wherein said paper product after exposure to water, exhibits at least two of the following characteristics selected from the group consisting of: (a) retention of structural strength; (b) retention of ink or pencil writing; (c) retention of print; and (d) retention of brightness.

18. The paper product of claim 17, wherein said paper product after exposure to water, exhibits at least three of the following characteristics selected from the group consisting of: (a) retention of structural strength; (b) retention of ink or pencil writing; (c) retention of print; and (d) retention of brightness.

19. The paper product of claim 16, wherein said paper product is exposed to water for at least 1, 3, 7, 11, 14, 21, 25, 30, 35, 40, 45, 50, 55, or 60 days.

20. The paper product of claim 21 that is a label, shipping material, newspaper, vapor barrier, garden marker, or underwater marking.

21. A process of making paper products, said process comprising (a) providing a paper substrate; (b) applying a composition to said paper substrate; and (c) curing said paper substrate comprising said composition, wherein said composition comprises:
(i) nano-fillers selected from SiO₂ or Al₂O₃;
(ii) at least one photo-initiator comprising an α-hydroxyketone;
(iii) at least one monofunctional monomer comprising an acrylate;
(iv) a diluent for oligomers, said diluent comprising an acrylate;
(v) a surfactant comprising a cross-linkable, silicone acrylate; and
(vi) optionally; a pigment dispersion and a second photoinitiator comprising benzoyl diaryl phosphine oxide.

22. The process of claim 21, wherein step (b) comprises:
(i) providing a lens with the composition; and
(ii) spinning the lens of (i) to apply said composition to said paper substrate; and step (c) comprises exposing the paper substrate to at least one source of ultraviolet light.

23. The process of claim 21, wherein the composition is partially impregnated into the paper substrate.

24. A paper product produced by the process of claim 21.

25. The paper product of claim 22, wherein said paper product is exposed to water and exhibits at least one, two, three, or four of the following characteristics selected from the group consisting of: (a) 95-100% retention of structural strength; (b) 95-100% retention of ink or pencil writing; (c) 95-100% retention of print; and (d) 95-100% retention of brightness.
